(19) United States
(12) Patent Application Publication
(10) Pub. No.: US 2024/0354637 A1
(43) Pub. Date: Oct. 24, 2024

(54) COMPUTING A HIERARCHY OF CLASS LABELS FOR HIERARCHICAL MULTI-LABEL CLASSIFICATION

(71) Applicant: Kyndryl, Inc., New York, NY (US)

(72) Inventors: Glincy Mary Jacob, Chengannur (IN); Omar Odibat, Cedar Park, TX (US)

(21) Appl. No.: 18/138,582

(22) Filed: Apr. 24, 2023

(51) Int. Cl. G06N 20/00

(52) U.S. Cl. CPC G06N 20/00

(57) ABSTRACT

A computer-implemented method, in accordance with one embodiment, includes collecting attributes of a subject. Cause-effect-decision relationships of the attributes of the subject are determined. Custom attributes are derived based on the cause-effect-decision relationships of the attributes of the subject. Custom attribute relationships and labels for the derived custom attributes of the subject are identified based on the cause-effect-decision relationships of the attributes of the subject, the custom attribute relationships including at least one belongs-to relationship and at least one decision relationship. A hierarchy of the custom attributes is generated using a finite state automaton. A hierarchical multi-label classifier is created (e.g., trained) based on the generated hierarchy. The classifier is used to generate class label decisions associated with labels of the classifier to objects of the subject. The decisions are output.

### BACKGROUND

The present invention relates to hierarchical multi-label classification, and more specifically, this invention relates to hierarchical multi-label classification where the hierarchy is generated prior to training the classifier, as well as recognizing labels and/or hidden relationships between attributes when they are not defined.

Hierarchical multi-label classification is a classification technique in which a single instance may belong to multiple labels that are organized in a hierarchy. Using flat classification models for complex problems only provides performance measures for the entire model, whereas hierarchical multi-label classification models provide the same information with additional accuracy for each local model. A hierarchical multi-label classifier is trained with training data with class labels according to a defined hierarchy structure. The hierarchy structure is a tree that defines the relationship between the class labels.

### SUMMARY

A computer-implemented method, in accordance with one embodiment, includes collecting attributes of a subject. Cause-effect-decision relationships of the attributes of the subject are determined. Custom attributes are derived based on the cause-effect-decision relationships of the attributes of the subject. Custom attribute relationships and labels for the derived custom attributes of the subject are identified based on the cause-effect-decision relationships of the attributes of the subject, the custom attribute relationships including at least one belongs-to relationship and at least one decision relationship. A hierarchy of the custom attributes is generated using a finite state automaton. A hierarchical multi-label classifier is created (e.g., trained) based on the generated hierarchy. The classifier is used to generate class label decisions associated with labels of the classifier to objects of the subject. The decisions are output.

A computer program product, in accordance with one embodiment, includes a computer readable storage medium having program instructions embodied therewith. The program instructions are executable by a computer to cause the computer to perform the foregoing method.

A system, in accordance with one embodiment, includes a hardware processor and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a network architecture, in accordance with one embodiment of the present invention.

FIG. 2 is a diagram of a representative hardware environment that may be associated with the servers and/or clients of FIG. 1, in accordance with one embodiment of the present invention.

FIG. 3 is a depiction of a hierarchy of a hierarchical multi-label classifier, in accordance with one embodiment of the present invention.

FIG. 4 is a flowchart of a method, in accordance with one embodiment of the present invention.

FIG. 5 is a chart depicting the cause-effect-decision attributes for the task of cost optimization in cloud object storage, in accordance with one embodiment of the present invention.

FIG. 6 is an illustration of a custom relationship model and an exemplary hierarchical model for cost optimization of object storage, in accordance with one embodiment of the present invention.

FIG. 7 is a table of finite state automaton sextuple elements, in accordance with one embodiment of the present invention.

FIG. 8 is a table of parameters that define elements of the automaton, in accordance with one embodiment of the present invention.

FIG. 9 is a state transition diagram of the automaton of FIG. 7, in accordance with one embodiment of the present invention.

FIG. 10 is a flowchart of a method, in accordance with one embodiment of the present invention.

FIG. 11 is a table depicting generation of the hierarchy, in accordance with one embodiment of the present invention.

FIG. 12 is a plot of the decrease in choice of hierarchy after each state, in accordance with one embodiment of the present invention.

FIG. 13 is a table depicting results of an experiment testing accuracy in which a multi-label classifier was trained with all possible hierarchies, for comparison with the single hierarchy generated according to the methodology presented herein.

FIG. 14 depicts a cloud computing environment, in accordance with one embodiment of the present invention.

FIG. 15 depicts abstraction model layers, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for hierarchical multi-label classification where the hierarchy is generated prior to training the classifier, as well as recognizing labels and/or hidden relationships between attributes when they are not defined.

In one general embodiment, a computer-implemented method includes collecting attributes of a subject. Cause-effect-decision relationships of the attributes of the subject are determined. Custom attributes are derived based on the cause-effect-decision relationships of the attributes of the subject. Custom attribute relationships and labels for the derived custom attributes of the subject are identified based on the cause-effect-decision relationships of the attributes of the subject, the custom attribute relationships including at least one belongs-to relationship and at least one decision relationship. A hierarchy of the custom attributes is generated using a finite state automaton. A hierarchical multi-label classifier is created (e.g., trained) based on the generated hierarchy. The classifier is used to generate class label decisions associated with labels of the classifier to objects of the subject. The decisions are output.

In another general embodiment, a computer program product includes a computer readable storage medium having program instructions embodied therewith. The program instructions are executable by a computer to cause the computer to perform the foregoing method.

In another general embodiment, a system includes a hardware processor and logic integrated with the processor, executable by the processor, or integrated with and executable by the processor. The logic is configured to perform the foregoing method.

### Computer Environment

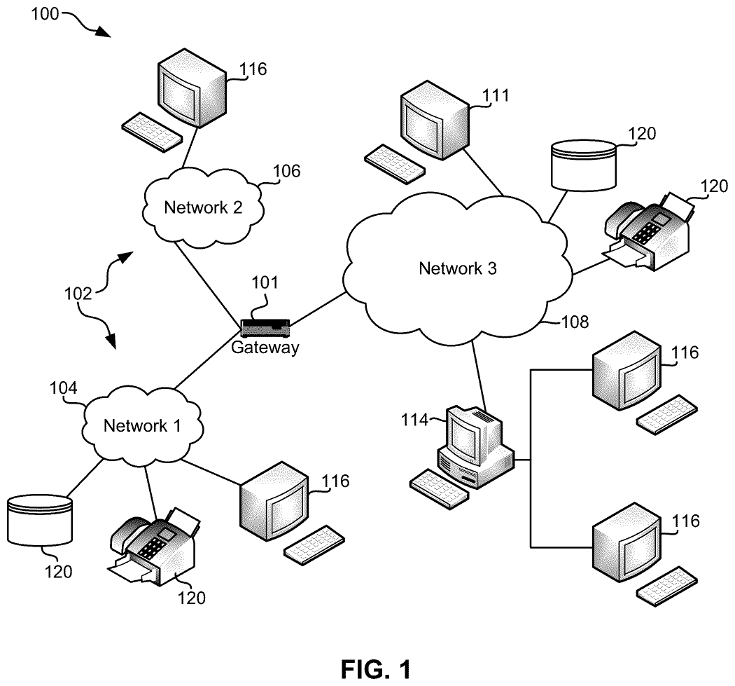

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a local area network (LAN), a wide area network (WAN) such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX® system which emulates an IBM® z/OS® environment (IBM and all IBM-based trademarks and logos are trademarks or registered trademarks of International Business Machines Corporation and/or its affiliates), a UNIX® system which virtually hosts a known operating system environment, an operating system which emulates an IBM® z/OS® environment, etc. This virtualization and/or emulation may be enhanced through the use of VMware® software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

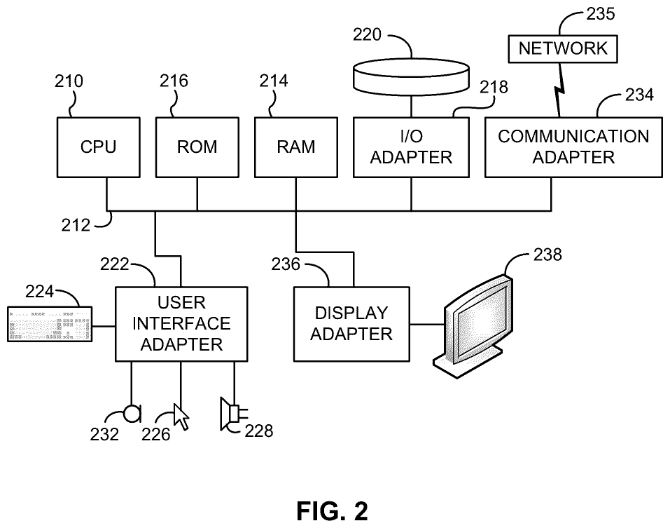

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an input/output (I/O) adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a macOS®, a UNIX® OS, etc. It will be appreciated that a preferred embodiment may also be implemented on platforms and operating systems other than those mentioned. A preferred embodiment may be written using extensible Markup Language (XML), C, and/or C++ language, or other programming languages, along with an object-oriented programming methodology. Object-oriented programming (OOP), which has become increasingly used to develop complex applications, may be used.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

### Hierarchical Multi-Label Classification

Hierarchical multi-label classification is a classification technique in which a single instance may belong to multiple labels that are organized in a hierarchy. Using flat classification models for complex problems only provides performance measures for the entire model, whereas hierarchical multi label classification models provide the same information with additional accuracy for each local model. The major requirements of hierarchical multi-label classification include training data with class labels and the hierarchy structure. The hierarchy structure is a tree that defines the relationship between the class labels.

Some of the most challenging classification problems in cloud, such as cost optimization of object storage, can be solved by structuring the subject for classification as a hierarchy of sub-classes in which the subject belongs to multiple sub-classes, where the sub-classes represent the independent or the derived attributes of the subject. The major challenge of this approach is that the hierarchy is not predefined and there could be hidden classes that lead to a tradeoff. For example, a hierarchical multi-label classifier with three levels and two labels at each level will have six possible ways of hierarchy, with each of them having 14 sub-classifiers. Some of these hierarchies might have a lesser number of sample data at early levels which contributes to the pruning of labels at early levels, thus contributing to error propagation to the subsequent levels, e.g., due to improper pruning and thus removal of a decision path. Moreover, a four level hierarchy might have 24 different possible combinations of hierarchies, which prior to the present invention, would have required training of 24 different hierarchical multi-label classifiers, then analyzing which classifier provides the highest accuracy, and then selecting that classifier. The time and computational resources required to do this is immense.

To avoid this, it would be desirable to infer the hierarchy ahead of the training of the classifier, as well as identify the relationship between classes. Then, that hierarchy can be used to train a single hierarchical multi-label classifier. The proposed approach presented herein can be used to identify the best hierarchy ahead of training the classifier.

The computational complexity of training a flat multi-label classifier is strongly affected by the number of labels. The methodology presented herein is independent of the classifier, and hence improves the accuracy of the hierarchical multi-label classifier by optimizing the hierarchy and not the classifier.

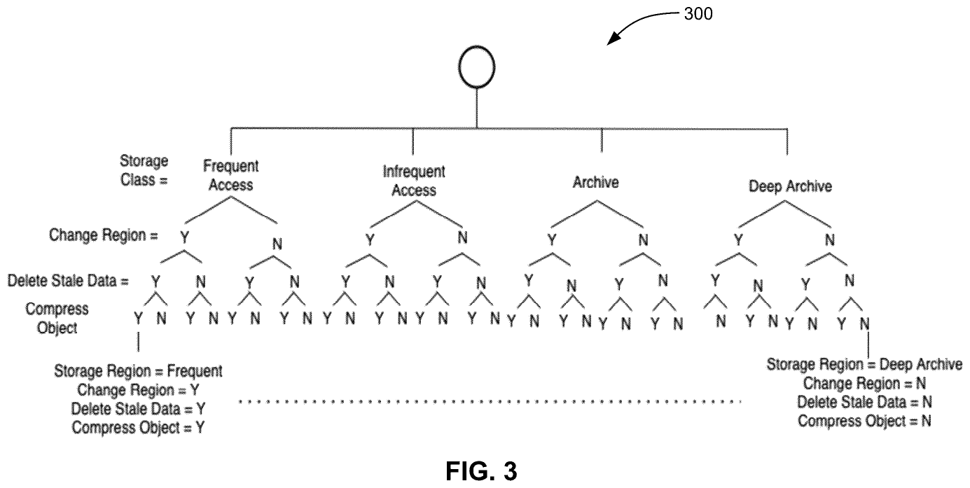

For example, by using a flat classifier for the problem of cost optimization of object storage in a cloud using the labels shown in the hierarchy 300 of FIG. 3, the classifier would have 32 labels, which affects the computational complexity of training a multi-label classifier. The sample count of training datasets associated with each label is less than the training dataset. However, a hierarchical multi-label classifier distributes the load to multiple classifiers rather than a single classifier. In various embodiments of the present method, the labels do not have any pre-defined hierarchy, and so the method aims to generate the hierarchy from all possible hierarchies ahead of training the classifier. This in turn vastly improves efficiency of training the classifier, and thus greatly reduces consumption of computer resources, in that the best hierarchy is determined without having to create classifiers for all possible hierarchies and testing each classifier to determine which one has the best hierarchy.

Moreover, the hierarchy is important because using the best hierarchy improves the efficiency and accuracy of the classifier. Early pruning of sub-classes in the training phase results in information degradation. An error in classification at the top of the hierarchy not only propagates down through the hierarchy, but the error is multiplied as it propagates through the hierarchy. Preferred embodiments presented herein identify the hierarchy that has the least error propagation by reducing the pruning of labels and placing the better balanced levels at the top of the hierarchy. Accordingly, the rate at which any error would be propagated to the subsequent levels is reduced.

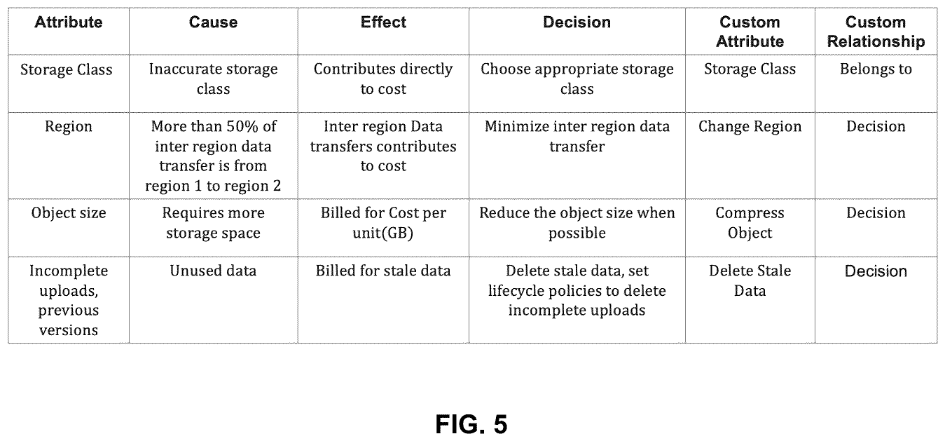

The present methodology, according to preferred embodiments discussed in more detail below, also models the hierarchy by identifying the cause-effect-decision relationship attributes of cloud objects and cloud assets, which can be anything found in a cloud-based system. Exemplary objects include files, volumes, databases, etc. Exemplary cloud assets include data storage drives, data storage systems, memory cards, network interfaces, storage controllers, etc. FIG. 5 depicts the cause-effect-decision attributes for the task of cost optimization in cloud object storage. Various embodiments represent custom attributes and their relationships as class labels for the hierarchical multi label classification.

The present methodology, while applicable to any situation that would become apparent to one skilled in the art after reading the present disclosure, is particularly useful for cloud objects and/or cloud assets that need multiple levels of classification on multiple attributes to solve a complex problem. The hierarchical structure of the multiple attributes is not predefined, but rather determined according to the methodology, based on analysis of attributes. Moreover, the methodology and resulting system, in various approaches, are classifier independent, and enhance the accuracy of the hierarchical multi-label classification problem by optimizing the hierarchy.

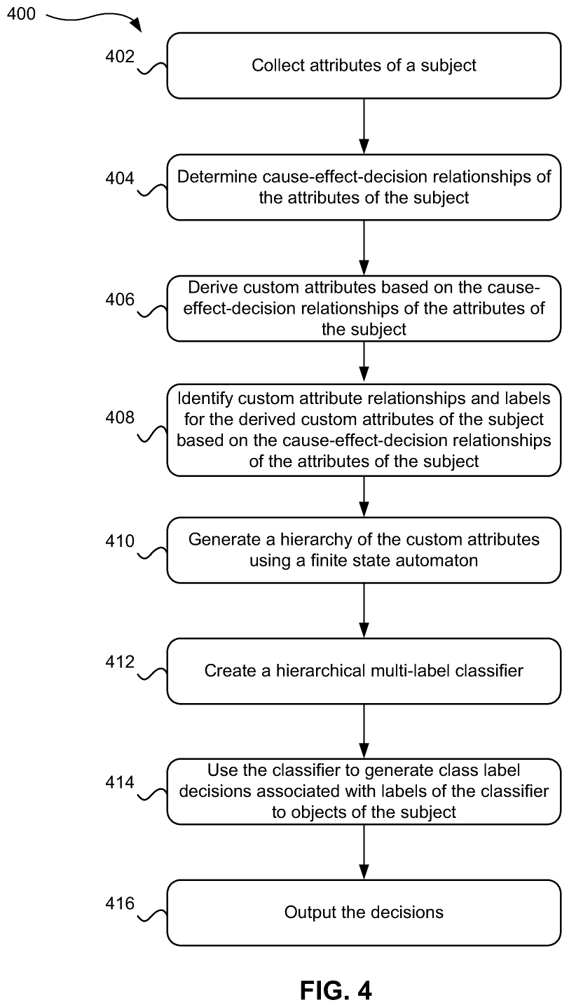

Now referring to FIG. 4, a flowchart of a method 400 is shown according to one embodiment. The method 400 may be performed in accordance with the present invention in any of the environments depicted in any of the other FIGS., among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, in which attributes of a subject are collected. The subject is the subject and/or objective of the classification. The attributes may be any characteristic or information about the objects and/or assets of the subject. In some approaches, the attributes may include metadata related to the objects and/or assets. Any number and/or class of attributes may be gathered, e.g., from a knowledge base, from the subject itself, etc. The number and/or class of attributes may be predefined, e.g., by a subject matter expert tasked with selecting the initial objects, assets and/or attributes. In some aspects, attributes corresponding to a list of predefined objects and/or assets may be gathered, e.g., automatically by the computer in a known manner, e.g., using a crawler, by querying a database, etc.

Presented throughout this description, by way of example only, is an exemplary performance of the method for a cloud based storage system (e.g., cloud object storage) as the subject/objective of the classification, and cloud-storage objects and/or assets of the cloud object storage as having attributes. This has been done by way of example only, and accordingly embodiments described herein are not restricted to a cloud subject. Rather, various approaches can be implemented for any domain, including those that would become apparent to one skilled in the art after reading the present disclosure.

FIG. 5 illustrates various attributes for the task of cost optimization in cloud object storage, according to the exemplary use case. As shown, the four attributes in this example are storage class, region, object size, and incomplete uploads, previous versions.

In order to define the subject as a hierarchy of its attributes, the attributes are categorized into custom attribute relationships in operations 404-408, as described in more detail below. In preferred approaches, the custom attribute relationships are a belongs-to relationship and a decision relationship, e.g., as shown in the last column of FIG. 5. An attribute is said to have a belongs-to relationship with the subject if the subject has a first order dependency with the attribute and directly contributes to the problem to be solved. A decision relationship is a derived action from an attribute that, when applied, indirectly or directly contributes to the solution of the problem. Belongs-to relationships are often multi-label, while decision relationships can have the decisions as the labels.

To determine the custom attributes and their relationships, in operation 404, cause-effect-decision relationships of the attributes of the subject are determined. The cause-effect-decision relationships may be determined from a predefined list, e.g., a list or input of such relationships created by a subject matter expert for the attributes; may be determined based on predefined information stored for general attributes, e.g., by selecting sample attributes most closely matching the actual attributes from a database of sample attributes and associated cause-effect-decision relationships; etc.

FIG. 5 depicts the cause-effect-decision attributes for the task of cost optimization in cloud object storage, in the exemplary use case for the problem of cost optimization in the exemplary cloud storage system. The cause of a cost-related issue, its effect on cost, and a decision about how to reduce the cost may be defined for each attribute, e.g., input by a subject matter expert, derived from a database relating causes/effects/decisions with possible attributes, determined by artificial intelligence, etc.

In operation 406, the custom attributes are derived based on the cause-effect-decision relationships of the attributes of the subject. In a preferred approach, custom attributes are derived by logical mapping of the metadata or any attribute that is associated with the subject. Referring again to the example in FIG. 5, the custom attribute may be derived as a representation of a solution to the issue noted in the cause column according to the decision for that issue. For example, looking to the Region attribute of FIG. 5, the Cause of an issue creating cost is that 50% of the inter region data transfer is from region 1 to region 2. The Effect is an increased cost of storage due to the data transfers. The Decision, to reduce cost, is to minimize the inter region data transfer. The custom attribute is thus whether to Change Region to reduce inter region data transfers. Any known manner of deriving the custom attributes that would become apparent to one skilled in the art after reading the present disclosure may be used in some embodiments.

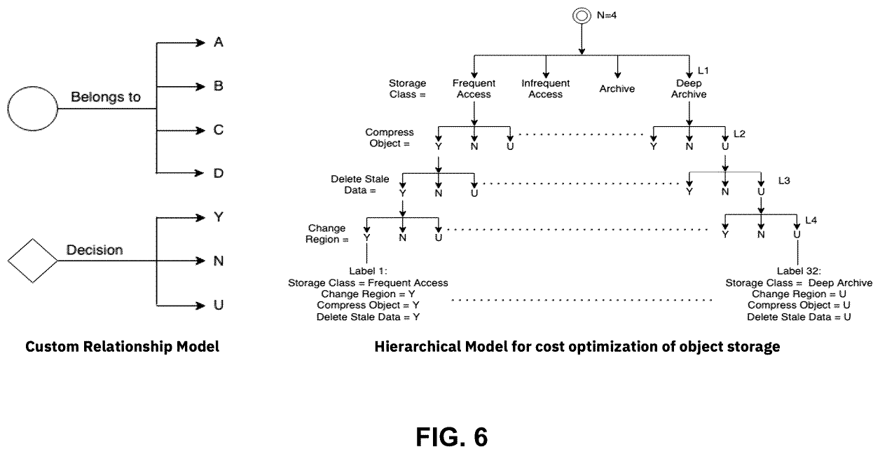

In operation 408, custom attribute relationships and labels for the derived custom attributes of the subject are identified based on the cause-effect-decision relationships of the attributes of the subject. Any attribute associated with the subject that directly or indirectly contributes to the objective of classification may be treated as an attribute. The mitigation of the effect the attribute produces may be encapsulated under a custom attribute. A custom attribute may generally be defined as an action and/or decision which has a relationship with the subject of classification, which when applied, relates to the classification. The custom attribute relationships include at least one belongs-to relationship and at least one decision relationship, e.g., according to a custom relationship model as shown in FIG. 6.

In a preferred approach, identifying the custom attribute relationships includes identifying an attribute as having a belongs-to relationship with the subject in response to determining that the subject has a first order dependency with the attribute and directly contributes to a problem to be solved by the classifier. An attribute is identified as having a decision relationship in response to determining that a derived action from the attribute, when applied, indirectly contributes to the solution of the problem.

Considering again the exemplary use case, cloud object storage can be represented as a hierarchy of its attributes for solving the problem of cost optimization. The cause-effect-decision relationship of the attributes of the exemplary cloud object storage is as shown in FIG. 5. The custom attribute storage class holds a belongs-to relationship with cloud object storage because it is directly proportional to the cost. The storage class is a multi-label attribute with labels such as Frequent Access, Infrequent Access, Archive and Deep Archive. The other custom attributes, Compress Object, Change Region, Delete Stale Data hold decision relationship with object storage because they indirectly contribute to the cost. The decision labels would be Yes or No. For example, inter region data transfers contribute to the cost of the object storage because of the belongs-to attribute, Region, needs correction. As shown in FIG. 6, each level in the hierarchy is dedicated to a single attribute and all the classifiers used at a particular level are the same.

Operation 410 includes generating a hierarchy of the custom attributes using a finite state automaton. Any known type of automaton that would become apparent to one skilled in the art after reading the present disclosure may be used. Preferably, generating the hierarchy includes computing a degradation rate and a balance coefficient for each of the possible hierarchies. The degradation rate is a rate at which the labels are pruned when the attributes are placed at each level in the hierarchy, and the balance coefficient defines how well samples for each attribute at each level are distributed.

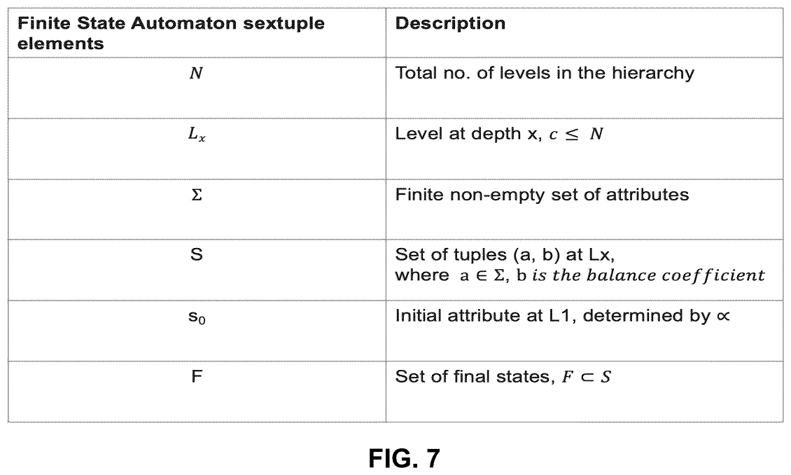

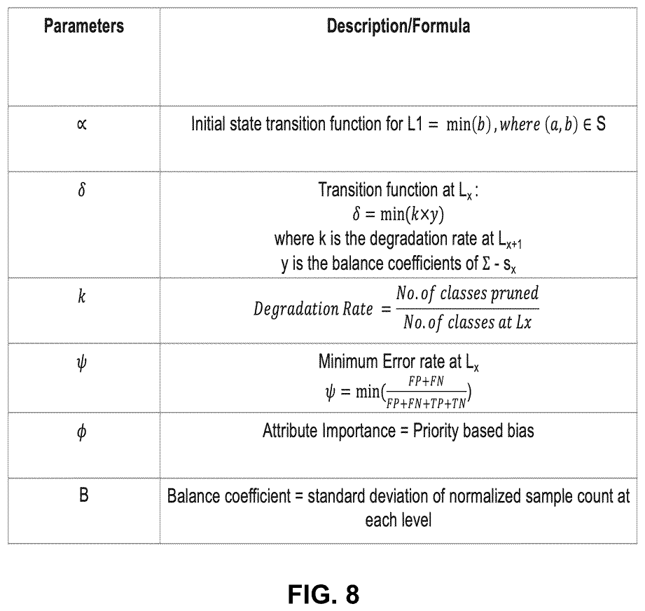

In a preferred approach, once the custom attributes and their relationships are identified, the hierarchy is generated by creating a finite state automaton represented by the sextuple as described in FIG. 7. The parameters and symbols that define the elements of the automaton are as shown in FIG. 8. The sub-level degradation rate and balance coefficient are computed using known techniques for each of the possible hierarchies.

Again, the degradation rate is the rate at which the labels are pruned when the attributes are placed at each level. The balance coefficient defines how well the samples for each attribute at each level are distributed. The degradation rate and balance coefficients are inversely proportional to the level number. For example, attributes with less degradation rate and balance coefficients are placed in the top levels of the hierarchy. A priority-based bias, attribute importance, is defined to give priority to direct derivatives of the attributes of the subject. The initial state function of the automaton determines which attribute must be placed at so. The initial state function is computed by finding the minimum of the balance coefficients of the attributes when placed at so. The transition function at any level is the minimum of the product of the degradation rate and balance coefficient for the attributes.

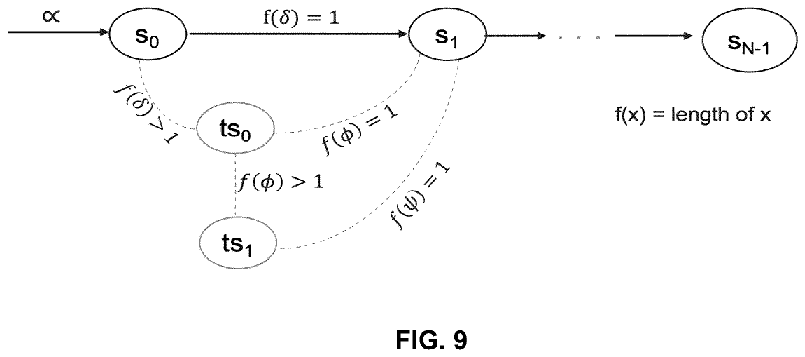

The state transition diagram of the exemplary automaton of FIG. 7 is as given in FIG. 9. The initial state transition function is used to compute the custom attribute that is placed at the first state so, which corresponds to the first level of the hierarchy. The next state is determined using a state transition function by computing the balance coefficients and degradation rates for the remaining attributes. If more than one attribute has the same transition function value, the automaton enters a transition state ts₀. Otherwise, the automaton moves to the next stable state sₓ₊₁. At ts₀, the transition function is determined by using the attribute importance. If more than one attribute has the attribute importance, the automaton enters the transition state ts₁. Otherwise, the automaton moves to the next stable state sₓ₊₁. At ts₁, the error rate for the conflicting hierarchies at Lₓ is computed. The attribute with the least error at Lₓ is set at sₓ₊₁. The automaton reaches a final state F when all the elements of S are exhausted and reduced to 1. The winning hierarchy is generated by placing the attributes at each state sₓ at the corresponding level Lx.

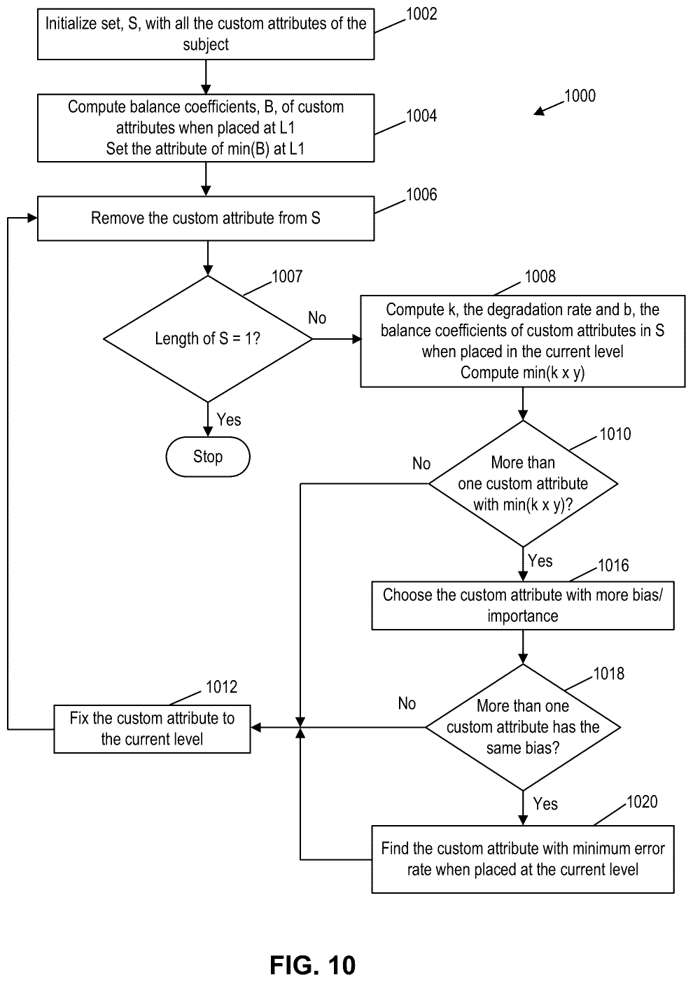

An illustrative state transition algorithm used by the automaton is depicted in FIG. 10. With continued reference to FIG. 10, a flowchart of a method 1000 is shown according to one or more embodiments. The method 1000 may be performed in accordance with the present invention in any of the environments depicted in any of the other FIGS., among others, in various embodiments. Of course, more or fewer operations than those specifically described in FIG. 10 may be included in method 1000, as would be understood by one of skill in the art upon reading the present descriptions.

Each of the steps of the method 1000 may be performed by any suitable component of the operating environment. For example, in various embodiments, the method 1000 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 1000. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 10, method 1000 may initiate with operation 1002, where a set S of all of the custom attributes is initialized.

In operation 1004, the initial state transition function is used to select one of the custom attributes to set at a first level L₁ of the hierarchy, the custom corresponding to a first state so. For example, balance coefficients B may be calculated for each of the custom attributes when placed at L₁, and the attribute with the min (B) is selected for placement at L₁. The balance coefficients B generally define how well the particular branching at each level can be balanced, to avoid improper pruning.

In operation 1006, the custom attribute which was set at L₁ is removed from the set.

A determination whether the length of the set S is 1 or greater is made at decision 1007, and if greater, the process proceeds to operation 1008 to process the remaining custom attributes at the next level Lₓ₊₁. Accordingly, the custom attributes remaining in the set are assigned to levels of the hierarchy by performing the following sequence.

In operation 1008, the next state is determined using a state transition function by computing balance coefficients B and degradation rates k for the custom attributes remaining in the set, for each custom attribute when placed in the current level Lₓ. A transition function value, min (k×y), is also computed.

At decision 1010, a determination is made as to whether more than one of the custom attributes have the same transition function value, min (k×y), determined in a known manner from the degradation rate k and balance coefficient, y (element of B). Here, min (k×y), is the minimum of products of balance coefficients and deflation rates.

If one of the custom attributes has a best (lowest) transition function value, the custom attribute is fixed to the current level in operation 1012.

If decision 1010 determines that more than one of the custom attributes have a same transition function value, a first transition state ts₀ is entered. See also FIG. 9.

In the first transition state, the bias and importance (‘attribute importance’) of the custom attributes are determined. See operation 1016. The bias and/or importance can be defined by a user, derived from predefined parameters, etc.

If only one of the custom attributes has the highest attribute importance, as determined at decision 1018, the process moves to the next stable state sₓ₊₁, and the process proceeds to operation 1012 where the custom attribute is fixed to the current level.

If more than one of the custom attributes have the highest attribute importance, a second transition state transition state ts₁ is entered into from the first transition state ts₀ at decision 1018.

When in the second transition state ts₁, the error rates for hierarchies at the current level Lₓ are computed in operation 1020, and the custom attribute with the least error at the current level is set at the next stable state sₓ₊₁. The process proceeds to operation 1012 where the custom attribute is fixed to the current level.

The process then returns to operation 1006, and if the length of S is not 1, the process returns to operation 1008. If the length of S is 1, the process ends.

In another approach, the levels are not set until later in the process. For example, when all of the custom attributes are at one of the states sₓ, as determined at decision 1007, the hierarchy is generated by placing the custom attributes at each state sₓ (e.g., the level to which assigned) into the corresponding level Lₓ of the hierarchy.

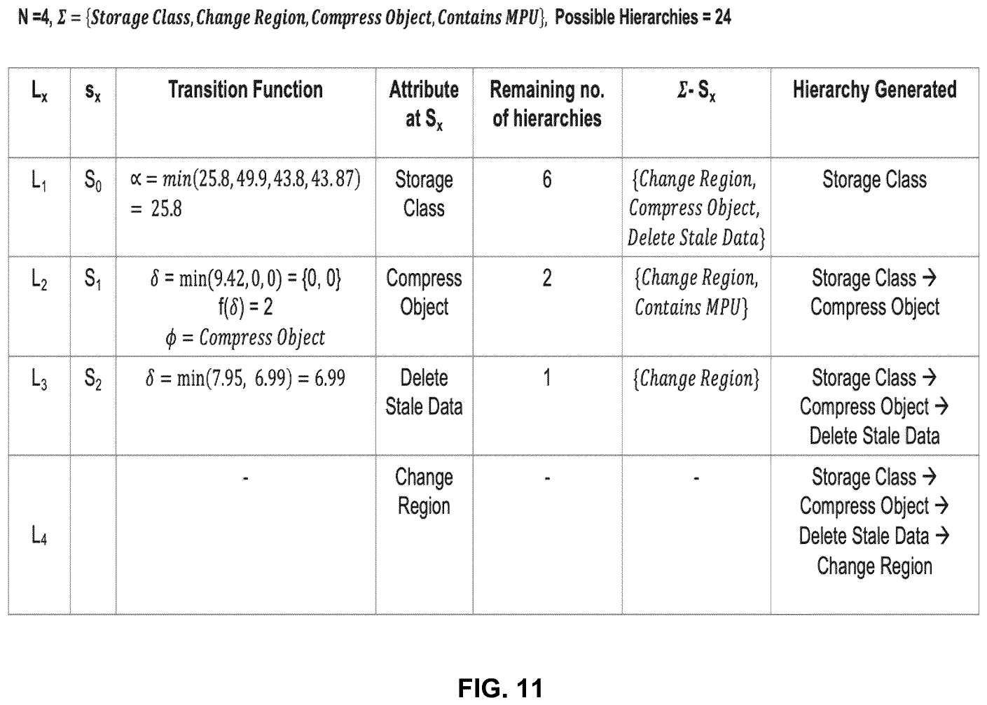

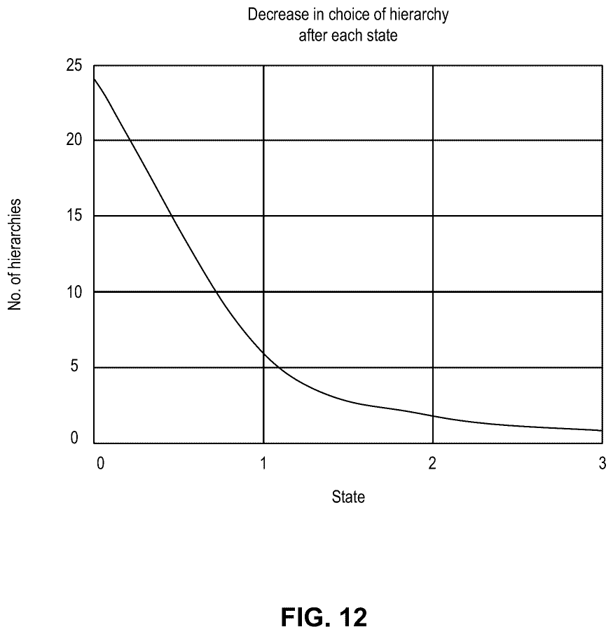

In the exemplary use case, the total number of levels in the hierarchy, N is 4. The hierarchy is generated by computing the attribute at all the states which is a subset of {Storage Class, Change Region, Compress Object, Delete Stale Data}. The state automaton proceeds by computing the S for each of the levels. The generation of the hierarchy is detailed in FIG. 11. As shown, for the depicted example, the winning hierarchy is Storage Class-Compress Object-Delete Stale Data-Change Region. As shown in the plot in FIG. 12, the choice of possible hierarchies is a function of falling factorial as the automaton traverses from so to F.

Note that method 1000 is performed using a computerized system, as the method 1000 cannot practically be performed by a human, given the complexities of the calculations and sheer amount of data that is processed. Moreover, any attempt by a human to perform such method 1000 would be expected to be rife with errors, again given the complexities of the calculations and sheer amount of data that is processed.

Using a process such as that described with reference to FIGS. 7-10, the best hierarchy for training the classifier can be generated without training all possible hierarchical multi-label classifiers for each of the many possible arrangements of the attributes or custom attributes.

Returning to FIG. 4, in operation 412, a hierarchical multi-label classifier is created, e.g., trained, based on the generated hierarchy. The training, using the generated hierarchy, may be performed in a conventional manner, e.g., using training data labeled by a subject matter expert.

The labels used in the classifier have no predefined hierarchy. Rather, the hierarchy is created by the method. Preferably, the label associated with each level in the hierarchy is a conjunction of the labels from the previous level and the current attribute. The final labels may be the conjunction of the sub-labels of all the levels. Each label is preferably a finite set of custom attributes of the subject. For example, the labels may define the descriptive behavior and characteristics of the subject, cloud object storage to solve the complex problem of cost optimization.

Training of the classifier, in some approaches, may be performed by applying a predetermined training data set to teach the classifier to process the data about the subject. Initial training may include reward feedback that may, in some approaches, be implemented using a subject matter expert (SME) that understands how the data from the hierarchical multi-label classification system should be processed with respect to the training data. In another approach, the reward feedback may be implemented using techniques for training a Bidirectional Encoder Representations from Transformers (BERT) model, as would become apparent to one skilled in the art after reading the present disclosure. Once a determination is made that the classifier has achieved a redeemed threshold of accuracy during the training, a decision that the model is trained and ready to deploy for use, e.g., as an artificial intelligence (AI) model, is made.

In operation 414 of FIG. 4, the classifier is used to generate class label decisions associated with labels of the classifier to objects of the subject. In operation 416, those decisions are output.

The decisions may be used for a plethora of purposes, such as to make decisions regarding the subject, to take an action regarding the subject and/or its attributes, and/or for any purpose that would become apparent to one skilled in the art after reading the present disclosure.

In some approaches, the class label decisions may be applied to objects of the subject to make changes to the subject. Continuing with the in use example, a change based on a class label decision to delete stale data may be to delete certain stale data stored in a particular class of storage in a particular region in order to reduce the cost of storage. Similarly, a class label decision change for a region may be to change the region of the asset to avoid inter region data transfers. Moreover, a belongs to relationship attribute such as storage class of a cloud object as a class label states which storage class the cloud object should be placed in.

Method 400 of FIG. 4 is at least partially, and ideally entirely, performed using a computerized system, as the method 400 cannot practically be performed entirely by a human, given the complexities of the calculations and sheer amount of data that is processed. Moreover, any attempt by a human to perform such method 400 would be expected to be rife with errors, again given the complexities of the calculations and sheer amount of data that is processed.

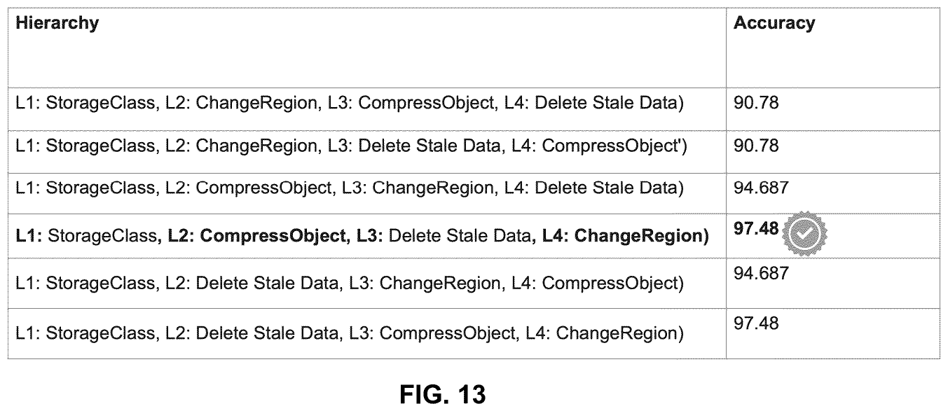

To prove the principle and operation of the present disclosure, experiments have been performed. These experiments are merely examples, which should not unduly limit the scope of the claims. In an experiment conducted according to the exemplary use case, the hierarchical multi-label classifier was trained with all possible 24 hierarchies. The hierarchies: Storage Class-Compress Object-Delete Stale Data-Change Region and Storage Class-Delete Stale Data-Compress Object-Change Region were found to have the highest accuracy. In the depicted example, as shown in FIG. 13, Compress Object was given higher attribute importance and priority at Level 2 (L2). The results of the experiment match the single hierarchy selected according to the methodology presented herein. This proves the principle of the present disclosure in an algorithmic way.

### Benefits and Practical Applications

As mentioned above, in the disclosed methodology, the labels do not need to have any predefined hierarchy. Rather, the hierarchy is generated from all possible hierarchies ahead of training the classifier. This in turn vastly improves efficiency of training the classifier, and thus greatly reduces consumption of computer resources, in that the best hierarchy is determined without having to train classifiers for all possible hierarchies and test each classifier to determine which one is most accurate and thus has the best hierarchy.

The ability to train a classifier efficiently without a predefined hierarchy but rather by creating the hierarchy is particularly useful for cloud-based subjects, because of the inherent unstructured nature of objects and assets in the typical cloud subject. The methodology presented herein makes use of hierarchical multi-label classification for cloud-based subjects practical.

Moreover, selection of the hierarchy is important because using the best hierarchy improves the efficiency and accuracy of the classifier. Early pruning of sub-classes in the training phase results in information degradation, and this is avoided in the present methodology. Also, the rate at which the error resulting from premature pruning would be propagated to the subsequent levels is reduced. Accordingly, the present methodology is able to identify the hierarchy that has the least error propagation by reducing the pruning of labels and placing the better balanced levels at the top of the hierarchy. Accordingly, not only are results of the classification better, but the rate at which any error would be propagated to the subsequent levels is minimized.

### Exemplary Cloud Environment

As noted above, the methodology presented herein is particularly applicable to use with cloud assets and objects. Moreover, the methodology may itself be implemented in a cloud based system.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

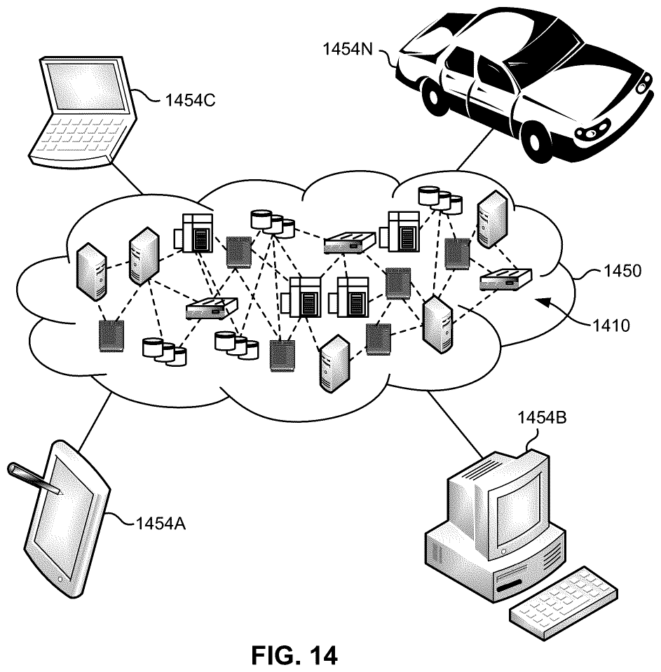

Referring now to FIG. 14, illustrative cloud computing environment 1450 is depicted. As shown, cloud computing environment 1450 includes one or more cloud computing nodes 1410 with which local computing devices used by cloud consumers, such as, for example, personal digital assistant (PDA) or cellular telephone 1454A, desktop computer 1454B, laptop computer 1454C, and/or automobile computer system 1454N may communicate. Nodes 1410 may communicate with one another. They may be grouped (not shown) physically or virtually, in one or more networks, such as Private, Community, Public, or Hybrid clouds as described hereinabove, or a combination thereof. This allows cloud computing environment 1450 to offer infrastructure, platforms and/or software as services for which a cloud consumer does not need to maintain resources on a local computing device. It is understood that the types of computing devices 1454A-N shown in FIG. 14 are intended to be illustrative only and that computing nodes 1410 and cloud computing environment 1450 can communicate with any type of computerized device over any type of network and/or network addressable connection (e.g., using a web browser).

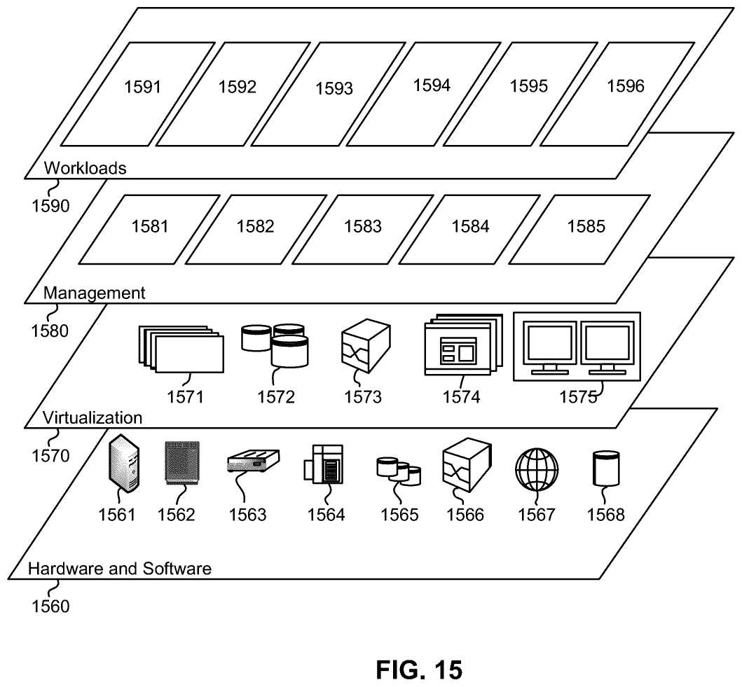

Referring now to FIG. 15, a set of functional abstraction layers provided by cloud computing environment 1450 (FIG. 14) is shown. It should be understood in advance that the components, layers, and functions shown in FIG. 15 are intended to be illustrative only and embodiments of the invention are not limited thereto. As depicted, the following layers and corresponding functions are provided:

Hardware and software layer 1560 includes hardware and software components. Examples of hardware components include: mainframes 1561; RISC (Reduced Instruction Set Computer) architecture based servers 1562; servers 1563; blade servers 1564; storage devices 1565; and networks and networking components 1566. In some embodiments, software components include network application server software 1567 and database software 1568.

Virtualization layer 1570 provides an abstraction layer from which the following examples of virtual entities may be provided: virtual servers 1571; virtual storage 1572; virtual networks 1573, including virtual private networks; virtual applications and operating systems 1574; and virtual clients 1575.

In one example, management layer 1580 may provide the functions described below. Resource provisioning 1581 provides dynamic procurement of computing resources and other resources that are utilized to perform tasks within the cloud computing environment. Metering and Pricing 1582 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1583 provides access to the cloud computing environment for consumers and system administrators. Service level management 1584 provides cloud computing resource allocation and management such that required service levels are met. Service Level Agreement (SLA) planning and fulfillment 1585 provide pre-arrangement for, and procurement of, cloud computing resources for which a future requirement is anticipated in accordance with an SLA.

Workloads layer 1590 provides examples of functionality for which the cloud computing environment may be utilized. Examples of workloads and functions which may be provided from this layer include: mapping and navigation 1591; software development and lifecycle management 1592; virtual classroom education delivery 1593; data analytics processing 1594; transaction processing 1595; and hierarchical multi-label classification 1596.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
collecting, by a computer, attributes of a subject;
determining, by the computer, cause-effect-decision relationships of the attributes of the subject;
deriving, by the computer, custom attributes based on the cause-effect-decision relationships of the attributes of the subject;
identifying, by the computer, custom attribute relationships and labels for the derived custom attributes of the subject based on the cause-effect-decision relationships of the attributes of the subject, the custom attribute relationships including at least one belongs-to relationship and at least one decision relationship;
generating, by the computer, a hierarchy of the custom attributes using a finite state automaton;
creating, by the computer, a hierarchical multi-label classifier based on the generated hierarchy;
using, by the computer, the classifier to generate class label decisions associated with labels of the classifier to objects of the subject; and
outputting the decisions.

2. The computer-implemented method of claim 1, wherein identifying the custom attribute relationships includes identifying the attributes of the subject as having the belongs-to relationship with the subject in response to determining that the subject has a first order dependency with the attributes and directly contributes to a problem to be solved by the classifier; and identifying the attributes of the subject as having the decision relationship in response to determining that a derived action from the respective attribute, when applied, indirectly contributes to a solution of the problem.

3. The computer-implemented method of claim 1, wherein generating the hierarchy includes computing degradation rates and balance coefficients for possible hierarchies, wherein the degradation rates are rates at which the labels for the derived custom attributes are pruned when the attributes are placed at a particular level in the hierarchy, and wherein the balance coefficients define how well samples for attributes at the respective levels are distributed.

4. The computer-implemented method of claim 1, wherein generating the hierarchy using the finite state automaton includes:
initializing a set of the custom attributes;
using an initial state transition function to select one of the custom attributes to fix to a first level of the hierarchy;
removing, from the set of the custom attributes, the custom attribute fixed to the first level;
assigning the custom attributes remaining in the set to levels of the hierarchy by performing the following sequence:
determining a next state using a state transition function by computing balance coefficients and degradation rates for the custom attributes remaining in the set;
in response to determining that one of the custom attributes remaining in the set has a best transition function value, fixing the one of the custom attributes at a current level;
in response to determining that more than one of the custom attributes remaining in the set have a same transition function value, entering a first transition state ts₀;
in response to entering the first transition state ts₀, determining whether more than one of the custom attributes remaining in the set have the same attribute importance;
in response to determining that none of the custom attributes remaining in the set have the same attribute importance, fixing the custom attribute having the highest attribute importance to the current level;
in response to determining that more than one of the custom attributes remaining in the set have the same attribute importance, entering a second transition state ts₁ from the first transition state ts₀;
in response to entering the second transition state ts₁, computing an error rate for hierarchies at the current level, and fixing the custom attribute with a least error to the current level; and
removing, from the set of the custom attributes, the custom attribute fixed to the current level.

5. The computer-implemented method of claim 1, wherein the hierarchy is generated without training every possible hierarchical multi-label classifier.

6. The computer-implemented method of claim 1, wherein the labels of the classifier have no predefined hierarchy.

7. The computer-implemented method of claim 1, comprising applying the class label decisions to the objects of the subject to make changes to the subject.

8. The computer-implemented method of claim 1, wherein the objects include cloud objects, cloud assets, or cloud objects and cloud assets.

9. The computer-implemented method of claim 8, wherein the subject is a cloud based storage system, wherein the objects include cloud-storage objects and cloud-storage assets in the cloud based storage system.

10. A computer program product, the computer program product comprising a computer readable storage medium having program instructions embodied therewith, the program instructions executable by a computer to cause the computer to:
collect, by the computer, attributes of a subject;
determine, by the computer, cause-effect-decision relationships of the attributes of the subject;
derive, by the computer, custom attributes based on the cause-effect-decision relationships of the attributes of the subject;
identify, by the computer, custom attribute relationships and labels for the derived custom attributes of the subject based on the cause-effect-decision relationships of the attributes of the subject, the custom attribute relationships including at least one belongs-to relationship and at least one decision relationship;
generate, by the computer, a hierarchy of the custom attributes using a finite state automaton;
create, by the computer, a hierarchical multi-label classifier based on the generated hierarchy;
use, by the computer, the classifier to generate class label decisions associated with labels of the classifier to objects of the subject; and
output, by the computer, the decisions.

11. The computer program product of claim 10, wherein identifying the custom attribute relationships includes identifying the attributes of the subject as having the belongs-to relationship with the subject in response to determining that the subject has a first order dependency with the attributes and directly contributes to a problem to be solved by the classifier; and identifying the attributes of the subject as having the decision relationship in response to determining that a derived action from the respective attribute, when applied, indirectly contributes to a solution of the problem.

12. The computer program product of claim 10, wherein generating the hierarchy includes computing degradation rates and balance coefficients for possible hierarchies, wherein the degradation rates are rates at which the labels for the derived custom attributes are pruned when the attributes are placed at a particular level in the hierarchy, and wherein the balance coefficients define how well samples for attributes at the respective levels are distributed.

13. The computer program product of claim 10, wherein generating the hierarchy using the finite state automaton includes:
initializing a set of the custom attributes;
using an initial state transition function to select one of the custom attributes to fix to a first level of the hierarchy;
removing, from the set of the custom attributes, the custom attribute fixed to the first level;
assigning the custom attributes remaining in the set to levels of the hierarchy by performing the following sequence:
determining a next state using a state transition function by computing balance coefficients and degradation rates for the custom attributes remaining in the set;
in response to determining that one of the custom attributes remaining in the set has a best transition function value, fixing the one of the custom attributes at a current level;
in response to determining that more than one of the custom attributes remaining in the set have a same transition function value, entering a first transition state ts₀;
in response to entering the first transition state ts₀, determining whether more than one of the custom attributes remaining in the set have the same attribute importance;
in response to determining that none of the custom attributes remaining in the set have the same attribute importance, fixing the custom attribute having the highest attribute importance to the current level;
in response to determining that more than one of the custom attributes remaining in the set have the same attribute importance, entering a second transition state ts₁ from the first transition state ts₀;
in response to entering the second transition state ts₁, computing an error rate for hierarchies at the current level, and fixing the custom attribute with a least error to the current level; and
removing, from the set of the custom attributes, the custom attribute fixed to the current level.

14. The computer program product of claim 10, wherein the hierarchy is generated without training every possible hierarchical multi-label classifier.

15. The computer program product of claim 10, wherein the labels of the classifier have no predefined hierarchy.

16. The computer program product of claim 10, comprising program instructions executable by a computer to cause the computer to apply the class label decisions to the objects of the subject to make changes to the subject.

17. The computer program product of claim 10, wherein the objects include cloud objects, cloud assets, or cloud objects and cloud assets.

18. The computer program product of claim 17, wherein the subject is a cloud based storage system, wherein the objects include cloud-storage objects and cloud-storage assets in the cloud based storage system.

19. A system, comprising:
a hardware processor; and
logic integrated with the processor, executable by the processor, or integrated with and executable by the processor, the logic being configured to:
collect attributes of a subject;
determine cause-effect-decision relationships of the attributes of the subject;
derive custom attributes based on the cause-effect-decision relationships of the attributes of the subject;
identify custom attribute relationships and labels for the derived custom attributes of the subject based on the cause-effect-decision relationships of the attributes of the subject, the custom attribute relationships including at least one belongs-to relationship and at least one decision relationship;
generate a hierarchy of the custom attributes using a finite state automaton;
create a hierarchical multi-label classifier based on the generated hierarchy;
use the classifier to generate class label decisions associated with labels of the classifier to objects of the subject; and
output the decisions.

20. The system of claim 19, wherein the hierarchy is generated without training every possible hierarchical multi-label classifier.
